(19) United States
(12) Patent Application Publication
(10) Pub. No.: US 2024/0033714 A1
(43) Pub. Date: Feb. 1, 2024

(54) STATIONARY PHASE MATERIALS AND DEVICES USED IN SIZE EXCLUSION CHROMATOGRAPHY

(71) Applicant: Phenomenex, Inc., Torrance, CA (US)

(72) Inventors: Michael Chitty, Torrance, CA (US); Arthur Roy Dixon, JR., Crestline, CA (US); James Song, Buena Park, CA (US); Zhengfei Sun, Buena Park, CA (US); Zijie Wang, Tustin, CA (US); Yinfeng Zong, Moorpark, CA (US)

(21) Appl. No.: 18/360,609

(22) Filed: Jul. 27, 2023

Related U.S. Application Data
(60) Provisional application No. 63/393,041, filed on Jul. 28, 2022.

(51) Int. Cl. B01J 20/32; B01D 15/34; B01J 20/283; B01J 20/286; B01J 20/10; B01J 20/28; B01J 20/30

(52) U.S. Cl. CPC B01J 20/3263; B01D 15/34; B01J 20/283; B01J 20/286; B01J 20/103; B01J 20/28097; B01J 20/28073; B01J 20/28004; B01J 20/3078; B01J 20/3085; B01J 20/28083; B01J 2220/4806; B01J 2220/56

(57) ABSTRACT

Disclosed are methods of making a porous particle material for use as stationary media and related chromatographic separation devices utilizing the disclosed stationary media. The porous particle material has a reduced pore volume which yields improved stability and column lifetime, and additionally has a surface coating, resulting in a surface modified porous particle material that minimizes unwanted adsorption interactions with samples to be tested

### CROSS-REFERENCE TO RELATED APPLICATIONS

This application is a U.S. Non-provisional Patent Application, which claims benefit and priority to U.S. Provisional Patent Application No. 63/393,041, filed on Jul. 28, 2022, titled “Stationary Phase Materials and Devices Used in Size Exclusion Chromatography”, the content of which is incorporated herein by reference in its entirety.

### FIELD OF INVENTION

The present invention relates stationary phase media for use in a chromatography columns. More specifically, the present disclosure relates size exclusion chromatography columns utilizing reduced pore size porous particles as the stationary phase.

### BACKGROUND

Size exclusion chromatography (hereinafter “SEC”) is the general name given to chromatographic separation techniques that involve liquid chromatography for the separation of macromolecules based on molecular size. SEC has become synonymous with other such chromatographic technique names, including as gel permeation chromatography (GPC), gel filtration chromatography (GFC), and steric exclusion chromatography.

The primary purpose and use of SEC techniques is to provide molecular weight distribution data about a biomolecule or synthetic molecules, for example, monoclonal antibodies, proteins, and polymer molecules. If a sample of interest contains a mixture of multiple molecules, the sample is injected at the head of a SEC column and a liquid mobile phase is passed through the column at a fixed flow rate, setting up a pressure gradient across its length. The column includes packing material which is typically porous, with a controlled pore size. As the sample passes through the packing material (the stationary phase), the small macromolecules are able to penetrate the pores of the packing material, but the larger molecules are too large to enter the pores and remain in the interstitial space. The larger molecules therefore flow more rapidly down the length of the column, while the smaller molecules are able to reside within and enter through the pores of the packing material. Due to their size difference, the various molecules are separated as they move down the column, and exit (elute) at different times. These various sized molecules are therefore separated and represented into distinct chromatographic bands.

When selecting a stationary phase medium there are several criteria to consider in SEC separation techniques. Firstly, the packing material should not interact chemically with the sample. Secondly, it must be mechanically stable and able to withstand operating temperatures and high operating pressures. Furthermore, it must have sufficient pore volume and an adequate range of pore sizes to resolve the sample's molecular weight distribution.

For High Performance SEC, meaning high pressure, the typical packing materials used are semirigid polymeric gels, or rigid modified silica particles. In general, rigid silica packing have several advantages over semirigid gel packing; they are tolerant of a greater variety of mobile phases, they are stable at elevated temperatures which be required to characterize certain polymers, and their pore sizes are more easily defined. However, silica-based packing do suffer from certain drawbacks, such as unwanted adsorptive effects, and some stability concerns under high operating pressures, particularly for smaller sized particles. This is particularly of concern as the silica particles utilized in modern day packing materials are getting smaller in size, for example 1.8 μm to 3 μm.

As the technology in this field has progressed, so have the demands on the chromatographic equipment. Higher pressure operations and reduced column sizes have been introduced for the purpose of speeding up the run time and obtaining quicker results. Currently, a typical column length is 30-50 mm, with a 2.0-4.6 mm diameter, and the particle sizes used for the stationary phase are commonly 3 μm and below. A decrease in particle size allows for a decrease in the column length, which in turn results in faster runs and overall time savings, in addition to increased chromatographic resolution.

However, various challenges are present with respect to decreased particle sizes for the stationary phase. Because modern chromatographic equipment is operated at higher pressures than before, the structural and mechanical integrity of the stationary phase particles has become increasingly important. The particles need to be mechanically strong to handle the repeated high pressures they are subjected to during the lifetime of a column. The longevity of the column is directly affected by the stability of the packed particles, and with increased number of runs, the packed particles in the stationary phase can experience particle breakdown.

In particular, with respect to fully porous particles, the structural/mechanical stability of the particle is effected by the pore volume present in the particle. As a general principle, the lower the pore volume of a particle the stronger and more stable the particle is under a high pressure environment. Conventional fully porous silica particles that are commonly used in today's chromatographic applications can have a porosity characterized by a pore volume of 1.4-1.8 cc/g. With larger particles, in the 3 μm range, this pore volume does not present a breakdown issue, as the larger particles are more mechanically stable. However, with smaller particles in the 1.6-1.8 μm range, the mechanical stability is highly effected by the porosity of the particle, as these particles experience breakdown more easily, and thereby affect the lifetime and the result reliability of the column. The porosity of the particles therefore has become an important factor in determining the lifetime of the equipment and the reliability of the results. As such, reducing the porosity of fully porous particles to make them more mechanically stable is of high interest in the industry.

Additionally, it is known that silica has a strong affinity toward polar solutes, which results in less than ideal packing material attributes when it comes to size exclusion chromatography. The amorphous nature of silica is reflected in the random distribution of various chemical structures on the surface. A silica particle typically has silanol groups (Si—OH) attached on the surface. Heating the particles typically condenses the bound silanol groups and results in the formation of siloxane bonds. There are free and bound silanol groups on the surface, and the free silanol groups constitute the premier adsorption and reaction sites on the surface of silica particles.

When it comes to the size exclusion of molecules such as proteins, these potential reaction sites contribute to what is commonly termed “non-size effects”, which generally includes all factors that affect the retention of proteins on SEC columns, other than the classic partitioning of solutes between pore volume and interstitial volume. These non-size effects include for example attractive interactions, such as ion-exchange and hydrophobic binding, which tend to increase the elution volumes of solutes, thus causing them to appear smaller than they actually are. Another interaction that occurs is electrostatic repulsion (ion exclusion) which has the effect of denying otherwise accessible volumes to the solutes, thereby causing them to appear larger than they are.

For the foregoing reasons, there exist a need for an SEC packing material that is more mechanically stable, particularly in high pressure operations, and also has is modified so to avoid ion exchange interactions and reverse phase interactions which are known to distort chromatographic results and accuracy.

### SUMMARY

The present invention relates to methods of making Size Exclusion Chromatography stationary phase material with increased mechanical stability and modified surface chemistries that minimize adsorption interactions of samples with the stationary phase material. Also disclosed are chromatographic separations devices using the improved stationary phase materials.

In one embodiment of the present invention, a method of making a stationary media (column packing material) is disclosed. In this embodiment the stationary media is a porous particle material. The porous particle material has initial characteristics and morphology, such as an initial pore volume, initial pore diameter, initial pore size, and initial average diameter, initial surface chemistry etc. The method comprises the steps of:
a. reducing the pore volume of the particle material from an initial pore volume to a final pore volume;
b. hydrating the porous particle material; and
c. coating the porous particle material with a hydrophilic compound to obtain a surface modified porous particle material.

In one embodiment, in the first step of the disclosed method a stock material of porous particles is provided with initial dimensions and morphology. In some embodiments, the porous particle material comprises Silica particles (SiO2). For particular Size Exclusion separations, depending on the molecules of interest, specific parameters are desired in terms of the stationary phase particle materials. In certain embodiments, those parameters include a specific desired pore volume, which is smaller than the pore volume of currently available stock silica materials. So a pore volume reduction step is performed so as to reduce the pore volume of the particle material from an initial pore volume to a final pore volume.

In one embodiment the step of reducing the pore volume of the particle material comprises thermally treating the particle material. This thermal treatment of the particle material results in dehydrating the particle material. Specifically relating to silica particles, a thermal treatment step results in a dehydroxylation reaction occurring on the surface of the silica particles. The surface of the particles contains silanol groups (Si—OH), which can be removed upon thermal processing.

The step of reducing the pore volume of the particle material is critical to providing a stationary phase material that is structurally and mechanical more stable than currently available materials, and is capable of withstanding high operating pressures, without experiencing particle breakdown. A more mechanically stable particle material results in allowing separation devices to be operated at higher pressures, and thus yielding faster results. It also results in a longer lifetime of a separation column which allows for more samples to be run prior to the column having to be replaced.

The particle material can be comprised of particles having an average diameter size in the range of about 1.0-3.0 μm. In one embodiment, the particle diameter is in the range of about 1.2-2.8 μm. In a further embodiment, the particle diameter is in the range of about 1.4-2.6 μm. In another embodiment, the particle diameter is in the range of about 1.6-2.4 μm. In a further embodiment, the particle diameter is in the range of about 1.8-2.2 μm. In an even further embodiment, the particle diameter is in the range of about 2.0-2.2 μm.

In some embodiments, the particle material comprises particles that have a porosity characterized by an initial pore volume in the range of 1.0-1.8 cc/g. In other embodiments, the initial pore volume is in the range of 1.1-1.7 cc/g, or any value therebetween. In further embodiments the initial pore volume is in the range of 1.2-1.6 cc/g, 1.3-1.5 cc/g, or any value therebetween.

When the first step of the disclosed methods is carried out, the resulting particle material has a reduced porosity characterized by a final pore volume in the range of 0.7 to 1.1 cc/g, or any value therebetween. In some embodiments, the final pore volume can be reduced in the range of 0.8 to 1.0 cc/g, or any value therebetween.

The secondary step of the methods disclosed herein comprises a step of hydrating the particle material, which has already undergone the pore reduction thermal processing step. The step of hydrating the particle material is carried out so as to reintroduce functionality to the surface of the particle material, for further chemical bonding that will occur during the subsequent coating step.

Once the hydrating step has been completed the silica particle material can the processed with a coating step. The coating step is carried out so as to ensure that the surface functionality of the particle material is such that ion exchange interactions and reverse phase interactions are prevented during the time that the sample interacts with the particle material within a separation column.

In one embodiment the coating step uses a very hydrophilic silane compound as a reagent for conducting the coating step on the silica particles. This hydrophilic silane has multiple —OH groups and results in the surface of the silica particle becoming similar to the water mobile phase, thereby reducing chemical interactions with the molecules contained within the sample. The silane coating also ensures that the silanol groups remaining on the silica surface are neutralized and do not have an ion exchange interactions with the molecules of interest contained in the sample to be tested. The coating steps in the present method are carried out simply in the presence of water, with the aid of an acidic catalyst. Prior silane coatings known in the art have been synthesized in Toluene, however the inventors of the present invention have surprisingly discovered that this step can instead be carried out simply in an aqueous mixture with a catalyst.

In an embodiment of the present disclosure the step of coating the porous particle material with a hydrophilic compound comprises:
a. preparing an aqueous mixture comprising a catalyst;
b. adding the hydrophilic compound to the aqueous mixture;
c. adding the porous particle material to the mixture of step b) and reacting the hydrophilic compound with porous particle material to form a coating on the porous particle material and obtain a surface modified porous particle material.

In other embodiments, the step of coating the porous particle material with a hydrophilic compound comprises combining the reaction solvents and reagents in the following specific amounts:
a. mixing 6× amount of water with 0.1× amount of catalyst;
b. adding 1/3× amount of hydrophilic compound to the water and catalyst mixture;
c. reacting the hydrophilic compound with 1× of the porous particle material, to obtain a surface modified porous particle material.

The value X represents the amount porous particle material by weight. The following example illustrates in more detail the coating procedure that is performed on the porous particle material.

In other embodiments, a chromatographic separation device is disclosed, which comprises:
at least one columnar member having an inner void;
at least one stationary packing material within the inner void;
   wherein the stationary packing material comprises a reduced pore volume and surface modified particle material, according to the methods disclosed herein.

In certain embodiments, the stationary packing material comprises silica particles, having an average pore volume of about 0.7 to 1.1 cc/g. In another embodiment, the silica particles have an average pore volume of about 0.8 to 1.0 cc/g. In a further embodiment, the silica particles have an average pore volume of about 0.9 cc/g.

In some embodiments, the chromatographic separation device is an SEC device or a Gel Filtration Chromatography device (GFC). GFC is used to separate large macromolecules such as antibodies, immunoglobulins, protein complexes, protein aggregates, peptides, and other biomolecules. In gel filtration chromatography, the compounds of interest in the sample move and filter through the stationary phase based on their molecular size. Typically aqueous solvents are used in the mobile phase to ensure that the compound of interest maintains biological integrity. Gel filtration columns can separate biomolecules that range from 200 to 1,500,000 Daltons in size. Gel filtration chromatography columns require a GFC stationary packing material that has low surface activity, high efficiency, and consistent uniform pore size.

In some embodiments, the columnar member of the chromatographic separation device has length of 150 mm, or 300 mm.

### Notation and Nomenclature

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

As used throughout this description, and in the claims, a list of items joined by the term “at least one of” or “one or more of” can mean any combination of the listed terms. For example, the phrase “at least one of X, Y or Z” can mean X; Y; Z; X and Y; X and Z; Y and Z; or X, Y and Z.

Full details of the present invention are set forth in the following description and illustrated in the accompanying drawings.

### BRIEF DESCRIPTION OF THE DRAWINGS

FIG. 1 is a graphical depiction illustrating the stability over 180 hours of operation of a size exclusion separation column (SEC) of the present invention, packed with reduced pore volume surface modified 1.8 micron size silica particles.

FIG. 2 is a graphical depiction illustrating the stability over 180 hours of a size exclusion separation column of the present invention operated at high pressures of 20K PSI, packed with reduced pore volume surface modified 1.8 micron size silica particles.

FIG. 3 is a graphical depiction illustrating the stability of a competitors column over a period of 160 hours, provided for comparative purposes.

FIG. 4 is a graphical depiction of chromatography results reliability and integrity after 302 runs on an SEC column disclosed in the present invention.

FIG. 5 is a graphical comparison of column stability, comparing Applicant's SEC column and a competitor's SEC column, under extreme running conditions over a period of 100 hours.

### DETAILED DESCRIPTION

The present invention relates to methods of making Size Exclusion Chromatography packing materials with increased mechanical stability and modified surface chemistries that minimize adsorption interactions of samples with the packing material. Also disclosed are chromatographic separations devices using the improved stationary phase materials.

In one embodiment of the present invention, a method of making a stationary media (column packing material) is disclosed. In this embodiment the stationary media is a porous particle material. The porous particle material has initial characteristics and morphology, such as an initial pore volume, initial pore diameter, initial pore size, and initial average diameter, initial surface chemistry etc. The method comprises the steps of:
a. reducing the pore volume of the particle material from an initial pore volume to a final pore volume;
b. hydrating the porous particle material; and
c. coating the porous particle material with a hydrophilic compound to obtain a surface modified porous particle material.

In one embodiment, in the first step of the disclosed method a stock material of porous particles is provided with initial dimensions and morphology. In some embodiments, the porous particle material comprises Silica particles (SiO2). For particular Size Exclusion separations, depending on the molecules of interest, specific parameters are desired in terms of the stationary phase particle materials. In certain embodiments, those parameters include a specific desired pore volume, which is smaller than the pore volume of currently available stock silica materials. So a pore volume reduction step is performed so as to reduce the pore volume of the particle material from an initial pore volume to a final pore volume.

In one embodiment the step of reducing the pore volume of the particle material comprises thermally treating the particle material. This thermal treatment of the particle material results in dehydrating the particle material. Specifically relating to silica particles, a thermal treatment step results in a dehydroxylation reaction occurring on the surface of the silica particles. The surface of the particles contains silanol groups (Si—OH), which can be removed upon thermal processing, typically in temperatures higher than 400° C., through the process of dehydroxylation. During this process, the bonds of the OH group and a hydrogen from an adjacent silanol, break away to form water as a result of a condensation reaction. This gives rise to siloxane Si—O—Si bridges. As the particles undergo this thermal treatment, and as the silanol groups are being removed, it is believed that the resulting siloxane bridges (Si—O—Si) forming inside the pores at the pore-solid interfaces likely give rise to rougher pore-solid interfaces and decrease the internal pore dimensions, thereby decreasing the pore size and pore volume.

The step of reducing the pore volume of the particle material is critical to providing a stationary phase material that is structurally and mechanical more stable than currently available materials, and is capable of withstanding high operating pressures, without experiencing particle breakdown. A more mechanically stable particle material results in allowing separation devices to be operated at higher pressures, and thus yielding faster results. It also results in a longer lifetime of a separation column which allows for more samples to be run prior to the column having to be replaced.

In some embodiment, the particle material is characterized by an initial porosity, wherein an average initial pore size in the range of 225-280 Angstroms. In further embodiments the initial average pore size is in the range of 255-275 Angstroms, or 260-270 Angstroms, or any value therebetween. After the thermal treatment methods of the present invention are carried out, the particle materials will have a final porosity characterized by a final average pore size in the range of 195-270 Angstroms (Å), or 200-240 A, or 205-235 A, or 210-230 A, or 215-225 A, or any value therebetween.

The particle material can be comprised of particles having an average diameter size in the range of about 1.0-3.0 μm. In one embodiment, the particle diameter is in the range of about 1.2-2.8 μm. In a further embodiment, the particle diameter is in the range of about 1.4-2.6 μm. In another embodiment, the particle diameter is in the range of about 1.6-2.4 μm. In a further embodiment, the particle diameter is in the range of about 1.8-2.2 μm. In an even further embodiment, the particle diameter is in the range of about 2.0-2.2 μm.

In some embodiments, the particle material comprises particles that have a porosity characterized by an initial pore volume in the range of 1.0-1.8 cc/g. In other embodiments, the initial pore volume is in the range of 1.1-1.7 cc/g, or any value therebetween. In further embodiments the initial pore volume is in the range of 1.2-1.6 cc/g, 1.3-1.5 cc/g, or any value therebetween.

When the thermal treatment process is carried out, the resulting particle material has a reduced porosity characterized by a final pore volume in the range of 0.7 to 1.1 cc/g, or any value therebetween. In some embodiments, the final pore volume can be reduced in the range of 0.8 to 1.0 cc/g, or any value therebetween.

The secondary step of the methods disclosed herein comprises a step of hydrating the particle material, which has already undergone the pore reduction thermal processing step. The step of hydrating the particle material is carried out so as to reintroduce functionality to the surface of the particle material, for further chemical bonding that will occur during the subsequent coating step. Since —OH groups are removed during the dehydroxylation reactions occurring in the thermal treatment of the particle material, once the pore reduction has taken place, some —OH groups need to be reintroduced on the surface of the silica particles so that the hydrophilic substance used in the coating step has a reaction site to bond to on the surface of the silica particle.

Therefore, in one embodiment of the present invention, the particle material, now having a reduced pore volume, undergoes a hydrating step wherein the porous particle material is sonicated with water for a period of time, then this aqueous particle mixture is added to a reactor and refluxed with a hydrofluoric acid (HF) solution. In the case of silica particles, Hydrofluoric acid solution breaks up strong Si—O bonds on the surface of the silica particles, and this allows for available reaction sites in a subsequent coating step.

Once this hydrating step is completed, the particle material has post-hydration parameters which include a post-hydration pore volume (cc/g) and post hydration pore sizes (Angstroms), examples of which are shown in Table 1 below. Table 1 outlines various particle material parameters, including the incoming raw silica particle initial pore volumes (P.V), initial pore size (P.S) and initial internal pore surface areas (S.A). Table 1 also details the parameters once the pore reduction thermal treatment step is completed, followed by the measured parameters once the hydrating step is completed.

TABLE 1

| | | | | Thermally treated silica | | | Hydrated silica | |
|---|---|---|---|---|---|---|---|---|
| | Raw silica particles | | | particles | | | particles | |
| Trial | S.A | P.V. | P.S. | S.A | P.V. | P.S. | P.V. | P.S. |
| # | (m2/g) | (cc/g) | (A) | (m2/g) | (cc/g) | (A) | (cc/g) | (A) |
| 1 | 247 | 1.61 | 274 | 176 | 0.91 | 195 | 0.94 | 206 |
| 2 | 247 | 1.61 | 274 | 177 | 0.93 | 198 | 0.94 | 208 |
| 3 | 242 | 1.57 | 272 | 175 | 0.92 | 200 | 0.91 | 208 |
| 4 | 246 | 1.6 | 272 | 167 | 0.87 | 204 | 0.87 | 205 |
| 5 | 242 | 1.57 | 272 | 177 | 0.93 | 201 | 0.95 | 214 |
| 6 | 231 | 1.48 | 274 | 175 | 1.1 | 243 | 1.08 | 259 |
| 7 | 231 | 1.48 | 274 | 159 | 0.96 | 238 | 0.98 | 249 |

Once the hydrating step has been completed the silica particle material can the processed with a coating step. The coating step is carried out so as to ensure that the surface functionality of the particle material is such that ion exchange interactions and reverse phase interactions are prevented during the time that the sample interacts with the particle material within a separation column.

In one embodiment the coating step uses a very hydrophilic silane compound as a reagent for conducting the coating step on the silica particles. This hydrophilic silane has multiple —OH groups and results in the surface of the silica particle becoming similar to the water mobile phase, thereby reducing chemical interactions with the molecules contained within the sample. The silane coating also ensures that the silanol groups remaining on the silica surface are neutralized and do not have an ion exchange interactions with the molecules of interest contained in the sample to be tested. The coating steps in the present method are carried out simply in the presence of water, with the aid of an acidic catalyst. Prior silane coatings known in the art have been synthesized in toluene, however the inventors of the present invention have surprisingly discovered that this step can instead be carried out simply in an aqueous mixture with a catalyst.

In an embodiment of the present disclosure the step of coating the porous particle material with a hydrophilic compound comprises:
a. preparing an aqueous mixture comprising a catalyst;
b. adding the hydrophilic compound to the aqueous mixture;
c. adding the porous particle material to the mixture of step b) and reacting the hydrophilic compound with porous particle material to form a coating on the porous particle material and obtain a surface modified porous particle material.

In some embodiments, the catalyst is an acidic compound. In one embodiment the acidic compound is hydrochloric acid (HCl). In this particular embodiment the HCl is used in a concentration of 0.1 N HCl. N represents Normality, which is another way to quantify solution concentration. It is similar to molarity but uses the gram-equivalent weight of a solute in its expression of solute amount in a liter (L) of solution, rather than the gram molecular weight (GMW) expressed in molarity.

The hydrophilic compound added to the aqueous mixture containing the catalyst can be a very hydrophilic silane compound. In one particular embodiment, the hydrophilic silane compound is glycidoxypropyltrimethoxysilane (GTMPS) or diethoxy(3-glycidyloxypropyl)methylsilane. When GTMPS is added to the aqueous solution, this causes a hydrolysis of the GTMPS resulting in a hydrolysed GTMPS, which can more easily adsorb and react with the silica surface.

The porous particle material, i.e. the porous silica particles, are then added to the aqueous mixture containing the GTMPS and allowed to react for a period of about 12 hours at a temperature of about 100° C. During this reaction, the GTMPS is adsorping on the surface of the silica particles, in a silylation reaction. The silylation of the silica surface by GTMPS significantly reduces the number of charged surface groups and silanol groups on the silica particles. GTMPS binds covalently to the silica surface and the epoxy ring on GTMPS opens and transforms into a diol (this can also be referred to a as diol bonded phase). The more GTMPS that is added to the aqueous solution, the higher degree of silylation that can occur, and hence the thicker the coating on the surface of the silica particles. The thickness of the coating can be analyzed base on % Carbon reading. This can be measured by an elemental analyzer. In some embodiments the % Carbon value of the coatings is between 3.0-7.0% Carbon.

In one embodiment the step of coating the porous particle material with a hydrophilic compound comprises combining the reaction solvents and reagents in the following specific amounts:
a. mixing 6× amount of water with 0.1× amount of catalyst;
b. adding 1/3× amount of hydrophilic compound to the water and catalyst mixture;
c. reacting the hydrophilic compound with 1× of the porous particle material, to obtain a surface modified porous particle material.

The value X here represents the amount porous particle material by weight. The following example illustrates in more detail the coating procedure that is performed on the porous particle material.

### Example 1

In a beaker, 6× of deionized water was added along with 0.1× of 0.1 N HCl (less than 6 months old) to the beaker. This mixture was then stirred. The pH of this mixture is monitored. The pH reading is close to a pH value of 2.75-3.0. The mixture is then placed in a reactor, and the reactor temperature is set to 25 C. Once the temperature of the mixture is stabilized and reading in the range of 25-30° C., 1/3× by volume of GTMPS is added to the mixture of water and HCl. The resulting mixture is stirred and the temperature is monitored. There will be a momentary temperature rise (in the range of 1.5-4° C.) due to exothermic reactions occurring. The mixture turns opaque, but becomes clear after about 10 minutes. Once the mixture is clear X grams of silica particles are added. The temperature set point of the reactor is set to 100° C., with a ramp up function of 50° C. per hour, and the reaction is allowed to proceed for a period of about 12 hours. The silica particles used in this example are 1.8 um sized particles that have previously undergone a pore reduction thermal treatment step and a hydrating step. Once the reaction has completed, the silica particles undergo a washing step, using filter paper and a Buchner funnel. 10X amount of deionized water is used to wash the silica particles, followed by 5X amount of methanol. The silica particles are then allowed to dry in an 80° C. environment for a period of 8 hours. Subsequently an Elemental Analyzer is used to measure the % Carbon of the silica particles, so that the silane coating on the particles can be quantified.

After the coating step is completed, the resultant particles are now silane coated silica particles with diol surface modifications, that allow for a reduction in ion exchange and reverse phase interactions with the molecules in the samples to be tested. The surface modifications that occur due to the silane coating make the silica particles have a surface functionality similar to water, hence making the packing materials surface chemistry similar to the mobile phase chemistry. Thus any interactions that occur between the sample and the packing materials are now solely due to size exclusion principles and are not altered by non-size dependent factors and interactions, such as adsorption of the molecule with reactive silanol groups on the surface of the particles. Because the silica particles are now diol modified surfaces, or diol bonded phase particles, they no longer have negatively charged silanol groups on the surface, that can interfere with the retention times of the analytes of interest. The diol ligand covers the silica surfaces as well as displays a polar functionality that mimics water, thereby rendering the surface of the silica particles similar to the aqueous mobile phase that are carrying the analyte/molecules past and through the stationary phase packing material.

The present disclosure further relates to chromatographic separation devices, particularly SEC devices, wherein the packing material used therein contains the porous particle materials, disclosed as part of this invention. These porous packing materials have a reduced pore volume, which provides an increased mechanical stability and longer lifetime to the separation device, and they further have and coating thereon yielding the surface modified particle material with decreased interactions with the analytes of interest.

The chromatographic separation devices disclosed herein are particularly useful in the analysis of monoclonal antibodies, biosimilars, and other biomolecules.

In one embodiment, a chromatographic separation device is disclosed, which comprises:
at least one columnar member having an inner void;
at least one stationary packing material within the inner void;
   wherein the stationary packing material comprises a reduced pore volume and surface modified particle material, according to the methods disclosed herein.

In certain embodiments, the stationary packing material comprises silica particles, having an average pore volume of about 0.7 to 1.1 cc/g. In another embodiment, the silica particles have an average pore volume of about 0.8 to 1.0 cc/g. In a further embodiment, the silica particles have an average pore volume of about 0.9 cc/g.

In some embodiments, the chromatographic separation device is an SEC device or a Gel Filtration Chromatography device (GFC). GFC is used to separate large macromolecules such as antibodies, immunoglobulins, protein complexes, protein aggregates, peptides, and other biomolecules. In gel filtration chromatography, the compounds of interest in the sample move and filter through the stationary phase based on their molecular size. Typically aqueous solvents are used in the mobile phase to ensure that the compound of interest maintains biological integrity. Gel filtration columns can separate biomolecules that range from 200 to 1,500,000 Daltons in size. Gel filtration chromatography columns require a GFC stationary packing material that has low surface activity, high efficiency, and consistent uniform pore size.

In some embodiments, the columnar member of the chromatographic separation device has length of 150 mm, or 300 mm.

The columnar member has an inner void with an inner diameter of 2.1 mm, or 4.6 mm, or 7.8 mm. wherein the porous packing material of the present invention is housed. The particle size for the stationary packing material housed in the columnar member can vary between 1.6-3.0 μm. In some embodiments, the average particle size of the packing material is about 1.8 μm, and in other embodiments a packing material having a 3.0 μm is used. This will depend on the type of analyte to be tested, and the size of the molecules of interest, in addition to the column size parameters. As disclosed above, the porous packing material within the columnar member of the separation device has a reduced pore volume, which results in increased stability of the packing material and increased lifetime of the columnar member of the chromatographic separation devices disclosed herein.

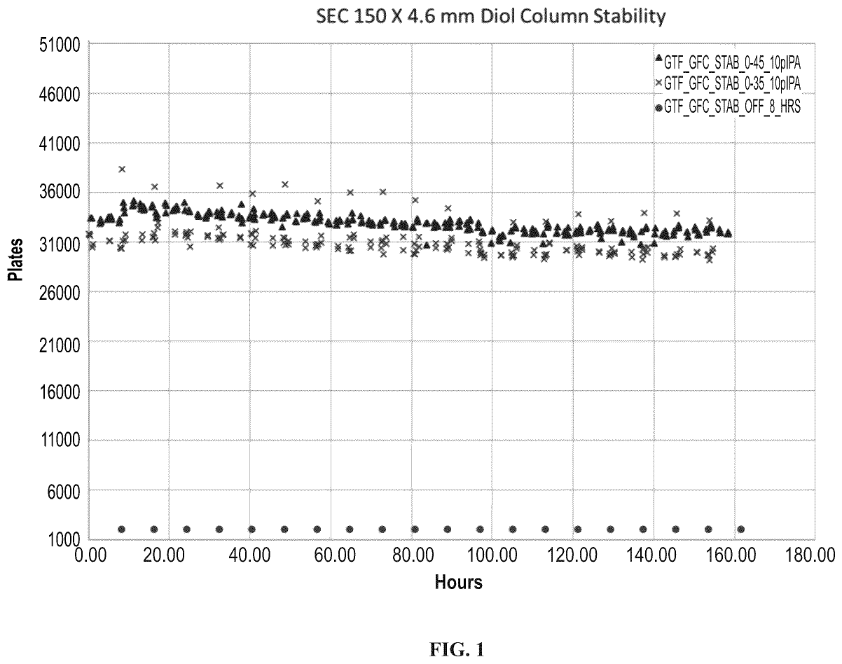

Moving now to the Figures, FIG. 1 graphically depicts the stability of a SEC device as disclosed herein. Column stability is depicted in terms of theoretical Plates (N) graphed against 180 hours of operation. Theoretical plate number (N) is an index that indicates column efficiency. It describes the number of plates as defined according to plate theory, and can be used to determine column efficiency based on calculation in which the larger the theoretical plate number the sharper the peaks.

The SEC column was packed with reduced pore volume, surface modified 1.8 micron size silica particles as the stationary media, with a packing pressure of 20,000 PSI. The column dimensions of this particular device were 150 mm length and 4.6 mm in diameter. The mobile phase flow rate for the runs depicted in this graph are 0.35 mL/min and 0.45 mL/min. Injected samples contained 50 ug/ml Uridine, with an injection volume of 0.7 μL. A combination of buffers was used with the aqueous mobile phase, 0.1 M NaPO4 and 10% Isopropanol.

As can be seen in FIG. 1, the column efficiency is maintained fairly steadily within 160 hours of operation of runs in various flow rate conditions described above. The theoretical plate index drops a minimal amount over the 160 hours of operation, which signifies that the stationary phase packing materials disclosed herein are able to maintain their stability and hence the stability and of the column itself, under high pressure conditions, over a long operation time.

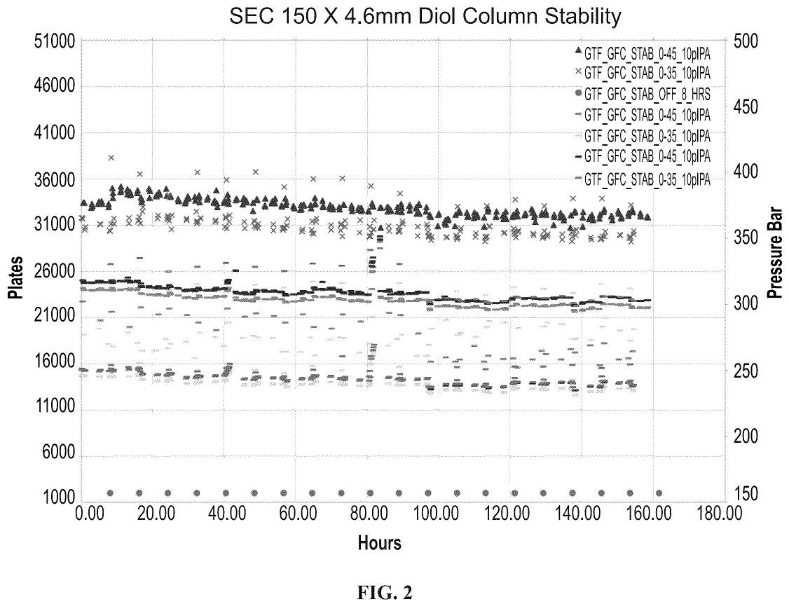

FIG. 2 similarly depicts the same sample runs as described above, performed at 0.35 mL/min and 0.45 mL/min, and with varied column pressures, as can be seen by the Y axis on the right of the graph showing a pressure range of 150 to 500 bar. Again here, the plate efficiency over 160 hours of runs, at the various flow rate and pressure conditions shown in the graph, has remained fairly steady with only a slight drop in Plates over 160 hours of operation. These results signify a high level of stability of the packing materials and a high degree of reliability of results.

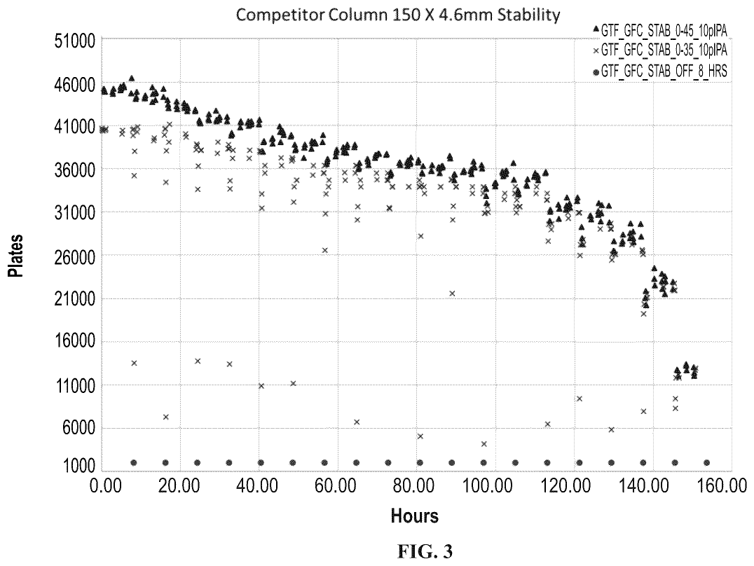

When compared to competitor SEC columns, the SEC devices designed and operated with the packing materials disclosed herein show a high degree of superiority in terms of column stability. This is further exemplified by FIG. 3, wherein a competitor column was tested, under the same conditions as those disclosed for the runs depicted in FIGS. 1 and 2. The same samples were run under the exact same conditions and buffer concentrations. The flow rates of the mobile phase tested were 0.35 mL/min and 0.45 mL/min, the injected samples contained 50 ug/ml Uridine, with an injection volume of 0.7 μL. The column stability of the competitor column was greatly diminished under operation to 150 hours. As can be seen by the data charted in the graph, the Plate efficiency dropped considerably beginning as early as 30-40 hours of operation. Whereas the SEC columns of the present invention, utilizing the disclosed reduced pore volume packing materials, maintained a nearly steady Plate efficiency even at 160 hours of operation.

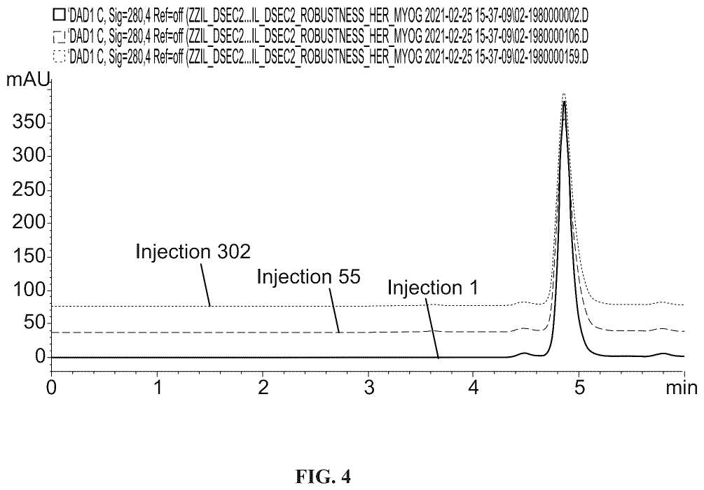

As can be seen in FIG. 4, the reduced pore volume silica particles of the present invention when loaded into the SEC columns of the present disclosure result in improved column lifetime and performance stability. FIG. 4 shows, three samples, Injection 1, Injection 55 and Injection 302, corresponding to the first, the 55th and the 302nd injection, respectively. As shown in FIG. 4, the output performance of the SEC column remains unchanged after 302 injections.

Comparing the samples shown in FIG. 4, it is evident that the elution time and peak volume of the samples is the same for the first and the 302^{nd} injection. This shows superior performance to existing and known columns, which typically experience column failure within 150-200 injections. This increased lifetime and stability of the column directly results from the increased mechanical robustness and stability of the reduced pore volume silica particles of the present invention. The reduced pore volume surface modified packing materials disclosed here, provide stationary phase materials which are less prone to early mechanical failure. When these packing materials are incorporated in SEC devices disclosed here, they yield separation devices with significantly increased lifetime and which maintain results integrity over much longer number of runs than currently available SEC columns.

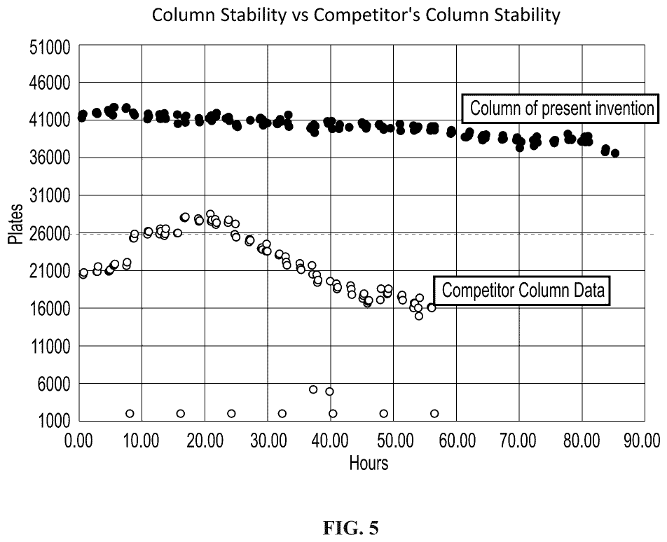

This is further demonstrated in FIG. 5, which shows unchanged performance efficiency after 90 hours of extreme running conditions for SEC columns of the present invention. A currently existing SEC column from a competitor was compared to an SEC column of the present invention. As can be seen by the results depicted in FIG. 5, the SEC column of the present invention had less than a 10% decrease in Plates (N), whereas the SEC competitor column of experienced a sharp decline in column efficiency beginning after 30 hours and eventually experience column failure within 50 hours of extreme running conditions. The standard commonly used silica packing materials of competitor's column cannot withstand rigorous running conditions, which leads to erratic results and eventually formation of a column “void”, and premature column failure. This is not the case with the SEC columns of the present invention, using the reduced pore volume silica particles disclosed here. As can be seen in Figure there is at least a 50% increase in column stability, as compared to the commonly used SEC column packing materials.

Although the present disclosure has been described with respect to one or more particular embodiments, it will be understood that other embodiments of the present disclosure may be made without departing from the scope of the present invention. Hence the present disclosure is deemed limited only by the appended claims.

The above specification, examples and data provide a complete description of the manufacture and use of the composition of the invention. Since many embodiments of the invention can be made without departing from the spirit and scope of the invention, the invention resides in the claims hereinafter appended.

Further examples and embodiments of the present invention are disclosed in the enumerated clauses which follow:

1. A method of making a porous particle material for use as stationary media in chromatographic separation, the method comprising the steps of:
a. reducing the pore volume of the particle material from an initial pore volume to a final pore volume;
b. hydrating the porous particle material; and
c. coating the porous particle material with a hydrophilic compound to obtain a surface modified porous particle material.

2. The method of clause 1, wherein the step of reducing the pore volume comprises performing a thermal treatment on the porous particle material.

3. The method of clause 1, wherein the step of reducing the pore volume comprises performing dehydroxylation reaction on the surface of the porous particle material.

4. The method of clause 1, wherein the step of hydrating the porous material comprises reacting the porous particle material with an aqueous Hydrofluoric acid Solution.

5. The method of clause 1, wherein the step of coating the porous particle material with a hydrophilic compound comprises;
a. preparing an aqueous mixture comprising a catalyst;
b. adding the hydrophilic compound to the aqueous mixture;
c. adding the porous particle material to the mixture of step b) and reacting the hydrophilic compound with porous particle material to form a coating on the porous particle material and obtain a surface modified porous particle material.

6. The method of clause 5, wherein the catalyst is an acidic compound.

7. The method of clause 5, wherein the catalyst is Hydrochloric Acid (HCl).

8. The method of clause 5, wherein the hydrophilic compound is a silane compound chosen from the group consisting of diethoxy(3-glycidyloxypropyl)methylsilane or glycidoxypropyltrimethoxysilane.

9. The method of clause 8, wherein the silane compound is glycidoxypropyltrimethoxysilane.

10. The method of clause 1, wherein the step of coating the porous particle material with a hydrophilic compound comprises;
a. mixing 6× amount of water with 0.1× amount of catalyst;
b. adding 1/3× amount of hydrophilic compound to the water and catalyst mixture;
c. reacting the hydrophilic compound with 1× of the porous particle material, to obtain a surface modified porous particle material;
wherein X represents the amount porous particle material by weight.

11. The method of clause 1, wherein an initial pore volume of the particle material is between 1.2-1.6 cc/g.

12. The method of clause 1, wherein a final pore volume of the particle material is between 0.7-1.1 cc/g

13. The method of clause 1, wherein the coating formed on the porous particle material is measured by % carbon content.

14. The method of clause 13, wherein the coating of the surface modified porous particle material comprises a % carbon content between 3.0-7.0%.

15. The method of clause 1, wherein the porous particle material has an average particle size between 1.6-3.0 μm.

16. The method of clause 1, wherein the porous particle material has an average particle size of 1.8 μm.

17. The method of clause 1, wherein the porous particle material has an average particle size of 3.0 μm.

18. The method of clause 1, wherein the porous particle material comprises Silica (SiO2) particles.

19. The method of clause 1, wherein the coating formed on the porous particle material has a thickness of between 3.0-3.7 μmol/m2.

20. The method of claim 1, wherein the coating formed on the porous particle material results in a surface modified particle material having a diol bonded phase.

21. A chromatographic separation device comprising:
at least one columnar member having an inner void;
at least one stationary phase packing material within the inner void;
wherein the stationary phase packing material comprises the surface modified porous particle material, prepared according to the method of Clause 1.

22. The chromatographic separation device of clause 21, wherein the chromatographic separation device is size exclusion chromatographic device.

23. The chromatographic separation device of clause 21, wherein the surface modified porous particle material comprises silica particles.

24. The chromatographic separation device of clause 21, wherein the surface modified porous particle material comprises a coating having 3.0-7.0% Carbon.

25. The chromatographic separation device of clause 21, wherein the surface modified porous particle material comprises a coating having a diol bonded phase.

26. The chromatographic separation device of clause 21, wherein the surface modified porous particle material comprises a coating having thickness of between 3.0-3.7 umol/m2.

27. The chromatographic separation device of clause 21, wherein the porous particle material comprises silica particles having a final pore volume of 0.7 to 1.1 cc/g.

28. The chromatographic separation device of clause 21, wherein the porous particle material comprises silica particles having a final pore volume of about 0.8 cc/g.

29. The chromatographic separation device of clause 21, wherein the porous particle material comprises silica particles having a an average particle size of 1.8-3.0 μm.

30. The chromatographic separation device of clause 21, wherein the porous particle material comprises silica particles having an average initial pore size of about 225-280 Angstroms.

31. The chromatographic separation device of clause 21, wherein the porous particle material comprises silica particles having an average final pore size of about 195-270 Angstroms.

32. The chromatographic separation device of clause 21, wherein the at least one columnar member has a length of 150 mm or 300 mm.

33. The chromatographic separation device of clause 21, wherein the inner void of the at least one columnar member has a diameter between 2.1 mm-7.8 mm.

34. The chromatographic separation device of clause 21, used for the separation of molecules selected from monoclonal antibodies, immunoglobulins, protein complexes, protein aggregates, peptides, and/or other biomolecules, or a combination thereof.

What is claimed is:

1. A method of making a porous particle material for use as stationary media in chromatographic separation, the method comprising the steps of:
a. reducing the pore volume of the particle material from an initial pore volume to a final pore volume;
b. hydrating the porous particle material; and
c. coating the porous particle material with a hydrophilic compound to obtain a surface modified porous particle material.

2. The method of claim 1, wherein the step of reducing the pore volume comprises performing a thermal treatment on the porous particle material.

3. The method of claim 1, wherein the step of reducing the pore volume comprises performing dehydroxylation reaction on the surface of the porous particle material.

4. The method of claim 1, wherein the step of hydrating the porous material comprises reacting the porous particle material with an aqueous hydrofluoric acid solution.

5. The method of claim 1, wherein the step of coating the porous particle material with a hydrophilic compound comprises;
a. preparing an aqueous mixture comprising a catalyst;
b. adding the hydrophilic compound to the aqueous mixture;
c. adding the porous particle material to the mixture of step b) and reacting the hydrophilic compound with porous particle material to form a coating on the porous particle material and obtain a surface modified porous particle material.

6. The method of claim 5, wherein the hydrophilic compound is a silane compound chosen from the group consisting of diethoxy(3-glycidyloxypropyl)methylsilane or glycidoxypropyltrimethoxysilane.

7. The method of claim 1, wherein the step of coating the porous particle material with a hydrophilic compound comprises;
a. mixing 6× amount of water with 0.1× amount of catalyst;
b. adding 1/3× amount of hydrophilic compound to the water and catalyst mixture;
c. reacting the hydrophilic compound with 1× of the porous particle material, to obtain a surface modified porous particle material;
wherein X represents the amount porous particle material by weight.

8. The method of claim 1, wherein an initial pore volume of the particle material is between 1.2-1.6 cc/g.

9. The method of claim 1, wherein a final pore volume of the particle material is between 0.7-1.1 cc/g

10. The method of claim 1, wherein the porous particle material has an average particle size between 1.6-3.0 μm.

11. The method of claim 1, wherein the porous particle material has an average particle size of 1.8 μm or 3.0 μm.

12. The method of claim 1, wherein the porous particle material comprises Silica (SiO₂) particles.

13. The method of claim 1, wherein the coating formed on the porous particle material has a thickness of between 3.0-3.7 μmol/m2.

14. The method of claim 1, wherein the coating formed on the porous particle material results in a surface modified particle material having a diol bonded phase.

15. A porous particle material according to claim 1.

16. A chromatographic separation device comprising:
at least one columnar member having an inner void;
at least one stationary phase packing material within the inner void;
wherein the stationary phase packing material comprises the surface modified porous particle material, prepared according to the method of claim 1.

17. The chromatographic separation device of claim 16, wherein the surface modified porous particle material comprises silica particles having a diol bonded phase.

18. The chromatographic separation device of claim 16, wherein the porous particle material comprises silica particles an average particle size of 1.8-3.0 μm and having a final pore volume of 0.7 to 1.1 cc/g.

19. The chromatographic separation device of claim 16, wherein the porous particle material comprises silica particles having an average initial pore size of about 225-280 Angstroms and an average final pore size of about 195-270 Angstroms.

20. The chromatographic separation device of claim 16, used for the separation of molecules selected from monoclonal antibodies, immunoglobulins, protein complexes, protein aggregates, peptides, and/or other biomolecules, or a combination thereof.
